(19) United States
(12) Patent Application Publication
(10) Pub. No.: US 2006/0089754 A1
(43) Pub. Date: Apr. 27, 2006

(54) An installed Vehicle Personal Computing (VPC) system with touch interaction, voice interaction or sensor interaction(s) that provides access to multiple information sources and software applications such as internet connected data applications, dynamic traffic-aware navigational routing, vehicle tracking, emergency accident dispatching, business applications, office applications, music and video player(s), personal info portal, vehicle monitoring, alarm and camera security and recording.

(75) Inventor: Andrew Eric Mortenson, Costa Mesa, CA (US)

Correspondence Address: ANDREW E. MORTENSON, 207 EAST 16TH STREET, COSTA MESA, CA, 92627, US

(73) Assignee: Andrew Eric Mortenson, Costa Mesa, CA (US)

(21) Appl. No.: 10/904,167

(22) Filed: Oct. 27, 2004

(51) Int. Cl. G05D 1/00

(52) U.S. Cl. 701/1

(57) ABSTRACT

A Mobile Vehicle Computer (MVC) unit with one or more Touch Display Interface(s) (TDI) for Land, Sea or Air vehicles which includes but not limited to: typical cars, trucks, recreational vehicles, airplanes, boats, governmental & military vehicles (Private or commercial). This system is an interactive mobile kiosk device type. The hardware and software consists of (but not limited or bound to) items listed in the following description: The touch screen, voice activation and sensor devices which control the programmed software modules, consisting of but not limited to or bound to and may be embedded or non-embedded software(s), to deliver information relating to traffic-aware vehicle navigation, GPS vehicle tracking application, Internet applications, email application, calendaring application, contact management application, tasks application, video application, audio application, and video broadcasts applications, an audio & video library manager and player applications, security & surveillance camera monitor applications, radio player applications (AM/FM/HD/satellite/internet), image viewing applications and educational program applications. Third party SDK (Software Development Kit) will be available for custom designed module development. This patent is not limited to or bound to by the above mentioned capabilities.

Definition List 1

| Term | Definition |
|---|---|
| Vehicle | Land, Sea or Air human |
| | transportation device |
| VPC | Vehicle Personal Computer |
| TDI | Touch Display Interface. |
| OEM | Original Equipment Manufacturer |
| Office Applications | Microsoft Office type applications |
| SDK | Software Development Kit |
| Module | An installable software component |

An installed Vehicle Personal Computing (VPC) system with touch interaction, voice interaction or sensor interaction(s) that provides access to multiple information sources and software applications such as internet connected data applications, dynamic traffic-aware navigational routing, vehicle tracking, emergency accident dispatching, web & business applications, office applications, music and video player(s), personal info portal, vehicle diagnostics, alarm and camera security and recording.

### DESCRIPTION

Short Descriptions of Figures

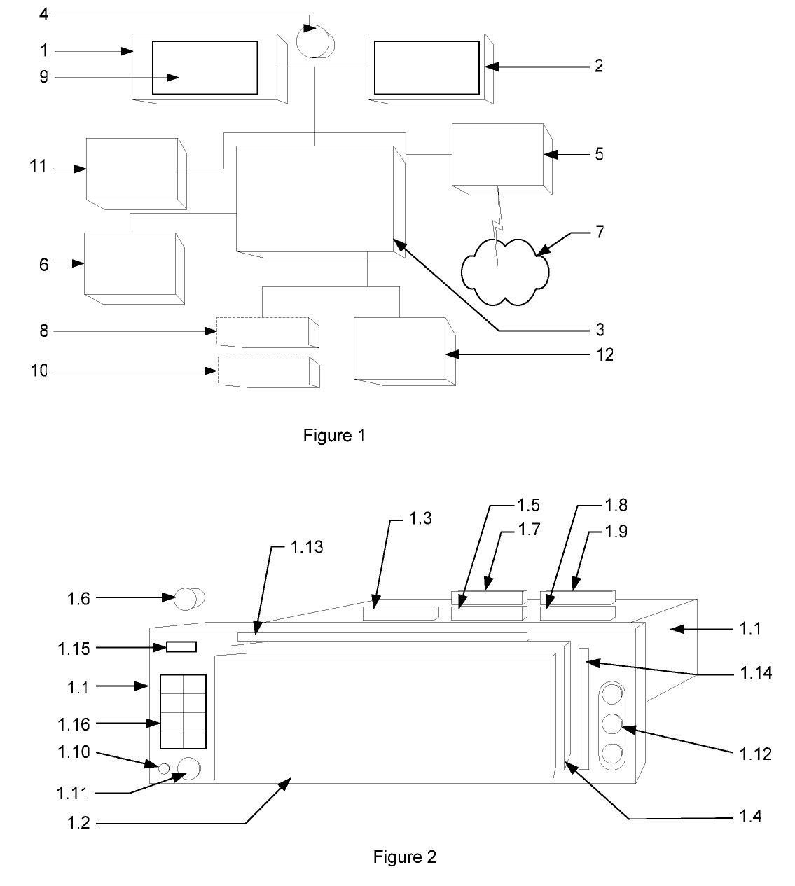

FIG. 1—Showing diagrammatically an isometric view of the total system. May consist of but not limited to:

1 Touch Display Interface (TDI) corded or wireless

2 Additional TDI(s) corded or wireless

3 VPC system and housing

4 Microphone

5 Multi-function antenna

6 GPS satellite connection

7 Internet connection

8 Vehicle OEM equipment integration adapter(s)

9 Software driven interface

10 Surveillance cameras

11 Multi-channel amplified loud speakers

not a part of this patent but a part of this total system

12 D/C power source

not a part of this patent but a part of this total system

Long Descriptions of Figures

FIG. 2—Display Panel

may consist of but not limited to:

1.1 Vehicle OEM designed TDI Bezel and Housing

1.2 Touch Screen Panel

1.3 Touch Screen Controller with connection to central computer

1.4 LCD Screen with Backlight display

1.5 Backlight inverter with connection to central computer

1.6 Microphone with connection to central computer

1.7 USB controller board with connection to central computer

1.8 VGA controller board with connection to central computer

1.9 12 v D/C Power connection

1.10 Reset Button

1.11 Master Volume Control/Power with connection to central computer

1.12 Audio/Video Inputs with connection to central computer

1.13 Slot Loading DVD/CD Reader/Writer

1.14 PCMCIA Interface

1.15 IR Receiver

1.16 Programmable Function Buttons

All of the above is mounted in an appropriate housing that conforms to all industrial standards including OEM.

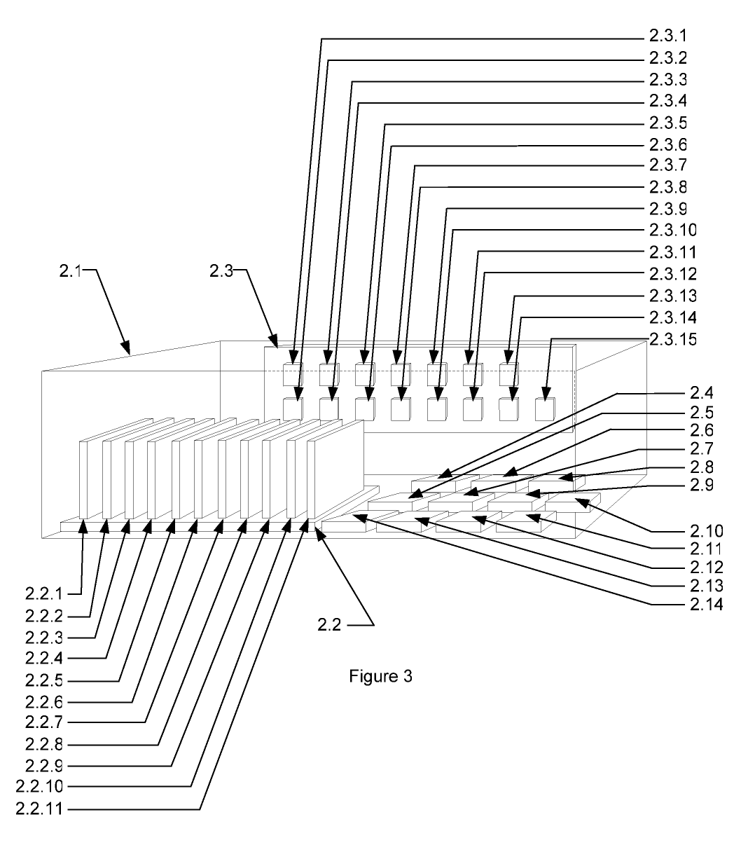

FIG. 3—Showing diagrammatically the central components. May consist of but not limited to:

2.1 Central Housing Enclosure with cooling device(s) and the following internal components:

2.2 Computer Motherboard with:

2.2.1 Central Processing Unit (CPU) and Appropriate Chipsets

2.2.2 Expandable Memory

2.2.3 PCI/Mini-PCI/AGP Expansion

2.2.4 Display/Video Adapter

2.2.5 USB, Fire Wire and Serial Bus

2.2.6 Sound Adapter

2.2.7 Ethernet Adapter

2.2.8 IR Interface

2.2.9 AM/FM Radio Receiver

2.2.10 PC Card Expansions

2.2.11 Future Expansion

2.3 I/O Connections with the following Interfaces.

May consist of but not limited to:

2.3.1 S/PDIF Optical Audio Interface

2.3.2 S/PDIF Coaxial Audio Interface

2.3.3 7.1 Surround Sound RCA Interface for standard amplified systems

2.3.4 VGA Port(s)

2.3.5 S-Video Port(s)

2.3.6 RCA Analog Video Port(s)

2.3.7 RCA Stereo Audio Input(s)

2.3.8 RCA Video Input(s)

2.3.9 Wi-Fi Antenna Port—Antenna Connection (See FIG. 3.0)

2.3.10 Automotive Antenna Port(s)

2.3.11 Ethernet Port(s)

2.3.12 USB Ports(s)

2.3.13 PCMCIA/CF Card Slot(s)

2.3.14 9-Pin Serial Bus Connection

2.3.15 12 v DC Power Connection with Remote-On

2.4 AM/FM/HD Stereo Receiver

2.5 Large Capacity Storage Device

2.6 Wi-Fi Adapter—Antenna Connection (see FIG. 3.0)

2.7 Cellular GPRS Modem Adapter—Antenna Connection (See FIG. 3.0)

2.8 OEM Audio Steering Wheel Controller Module

2.9 D/C Logical Power Supply

2.10 Cooling Device(s)

Optional peripherals may consist of but not limited to:

2.11 OBDII Adapter—Automotive Diagnostics Connection by others

2.12 Satellite XM Radio by others

2.13 Radar Scanner by others

2.14 Multi-Channel Amplified Audio System by others

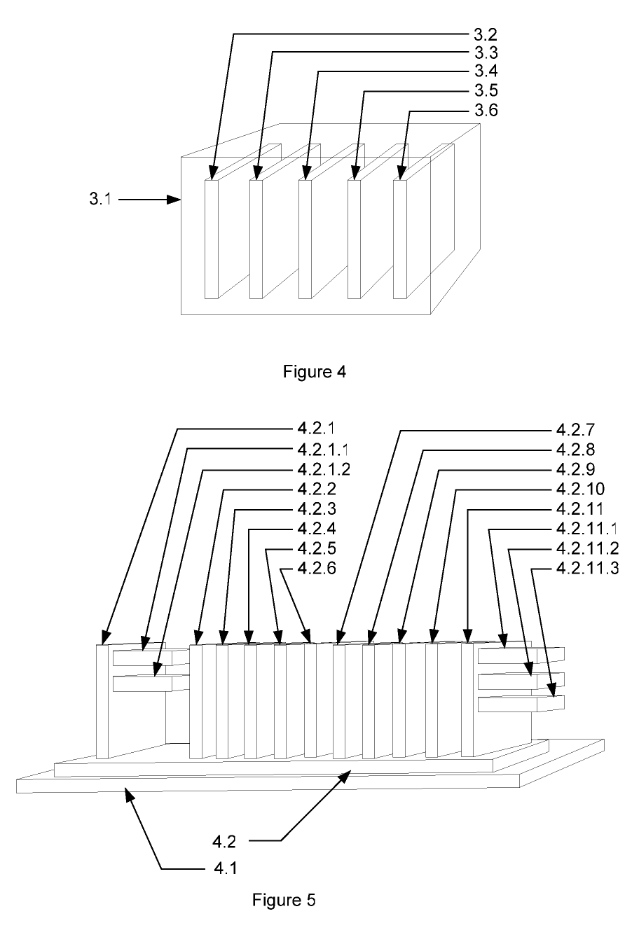

FIG. 4—Combined Multi-Function Antenna Device

may consist of but not limited to:

3.1 Dust and water proof enclosure incorporated into a roof mounted antenna.

3.2 Cell Phone Antenna

3.3 BlueTooth Transceiver

3.4 Wi-Fi/Wi-Fi Antenna

3.5 GPS Receiver

3.6 USB/Wireless Connectivity

FIG. 5—Computer Software Interface

May consist of but not limited to:

4.1 Windows XP/Embedded

4.2 Customizable Menu-Driven Software for Touch Display Interface(s) (TDI)

4.2.1 GPS Navigation and Traffic Routing Software

4.2.1.1 GPS Tracking Software

4.2.1.2 Dynamic Automotive Traffic Re-Routing

4.2.2 BlueTooth Device Integration (Laptop, Cell Phone, PDA, IPOD, etc)

4.2.3 Digital Music Player

4.2.4 Digital Video Player—Contained to rear seats while driving where required

4.2.5 Microsoft Office Integration Internet Browser Software

4.2.6 Portable Device Viewing Software

4.2.7 Educational Software

4.2.8 Security Software

4.2.9 Gaming Software

4.2.10 Internet Browser Software

4.2.11 System Configuration Settings

4.2.11.1 Core Configuration Settings

4.2.11.2 Add/Remove Modules

4.2.11.3 Individual Module Configuration Settings

What is claimed is:

1. Our traffic-aware navigational guidance software is unique and original to the vehicle industry.

2. Our vehicle software module system is unique and original to the vehicle industry.

3. Our combined Multi-Function Wireless antenna is unique and original to the vehicle industry.

4. Our product is the first commercially available Internet connected mobile vehicle personal computing system.

5. Our product is the first internet connected mobile Vehicle Web Portal.

6. Our product is the first computer vehicle tracking and security system with remote emergency dispatching.
